(19) United States
(12) Patent Application Publication
(10) Pub. No.: US 2004/0241400 A1
(43) Pub. Date: Dec. 2, 2004

(54) Embossed film and security document

(76) Inventors: Gunther Friedl, Oberasbach (DE); Uwe Nendel, Hemhofen (DE)

Correspondence Address: Charles R Hoffmann, Hoffmann & Baron, 6900 Jericho Turnpike, Syosset, NY, 11791, US

(21) Appl. No.: 10/490,669

(22) PCT Filed: Oct. 16, 2002
(86) PCT No.: PCT/DE02/03909

(30) Foreign Application Priority Data
Oct. 19, 2001 (DE) 101 51 150.7

(51) Int. Cl. B32B 5/16

(52) U.S. Cl. 428/202; 428/328; 428/327

(57) ABSTRACT

The invention concerns an embossing film, in particular a hot embossing film, including a transfer layer (7) arranged releasably on a carrier film (1), wherein the transfer layer (7) has at least one color layer (4) whose color appearance changes in dependence on a viewing angle, wherein the color layer contains colored interference pigments with a metal core. The invention further concerns a security document (8) produced using the embossing film.

The invention concerns an embossing film, in particular a hot embossing film, including a transfer layer arranged detachably on a carrier film, and a security document, in particular a banknote, a pass, an identity card, a cheque card, a credit card and the like.

Embossing films, in particular hot embossing films, are known in the state of the art. In the known embossing films the transfer layer is transferred from the carrier film, for example under the effect of heat and pressure, on to a substrate to which the transfer layer adheres using an adhesive layer which is generally a layer of hot melt adhesive or a layer of radiation-hardenable adhesive.

Hot embossing films are widely used in particular for applying security elements for example to value-bearing papers such as banknotes, credit cards, identity passes or other articles to be safeguarded.

DE 41 01 301 A1 discloses a security element comprising a film provided with a magnetic coating, the coating having light, soft-magnetic pigments. DE 41 01 301 A1 also discloses a security document produced using the security element. The improved security properties are intended to arise in particular by virtue of the use of soft-magnetic pigments which, in contrast to commercially available magnetic pigments, have magnetic properties and in that respect make it more difficult to forge the security element. In addition those soft-magnetic pigments involve a light coloration which are suitable for the production of a magnetic layer of a light inherent colour. That light magnetic layer differs from a conventional magnetic layer which is of a dark or black inherent colour. The light appearance can be enhanced by the additional application of a white colour layer over and/or under the magnetic layer.

There is the disadvantage here that the security element proposed in accordance with DE 41 01 301 A1 can be easily forged by applying a white cover layer on a conventional magnetic layer of dark or black inherent colour. Identifying the forgery of the security element known from DE 41 01 301 A1 can possibly be implemented only after an investigation of the magnetic properties. That however requires an additional examination step which frequently cannot be carried out on the spot. For example when a cheque card is being used in conjunction with an issued cheque, the procedure only involves optical checking of the card and a comparison between the signature on the cheque card and the signature on the cheque. When a light or white cover layer is applied to the dark or black magnetic layer of a forged cheque card, it cannot be readily detected as being a forgery.

DE 43 13 519 A1 discloses an embossing film comprising a carrier film and a transfer layer which can be detached therefrom, wherein the transfer layer is a decorative lacquer layer representing graphic elements and comprising a lacquer containing pigments which luminesce upon being irradiated with light of a defined wavelength. Identification of the transfer layer applied to a substrate can be effected by shining on light of a wavelength which results in luminescence of the pigments used.

Although the use of luminescent pigments in the transfer layer makes it possible to provide a markedly improved security element or security documents which are better safeguarded, it is only possible to check the authenticity of the security element, by shining thereon light of a defined excitation wavelength. Accordingly the operation of checking the authenticity of a security document produced in accordance with the teaching of DE 43 13 519 A1 requires a light source for producing light of the defined excitation wavelength. As such a light source is frequently not available the authenticity of such a security element cannot always be checked.

DE 199 07 697 A1 discloses a multi-layer transfer material having an optically variable material and in addition at least one machine-readable feature. Preferably fluid-crystalline materials or pearl lustre pigments (Iriodin®) are used as optically variable materials.

A disadvantage here is that the proposed optically variable materials do not involve a satisfactory change in colour in dependence on a viewing angle and accordingly do not satisfy the increased security requirements in relation to documents or articles to be safeguarded.

Accordingly the object of the invention is to provide an embossing film which makes it possible to provide security documents with a coating which makes forgery more difficult, wherein said coating is intended to permit identification of authenticity with the naked eye. A further object of the invention is to provide a security document provided with a coating which makes forgery more difficult.

A further object of the invention is to combine enhanced anti-forgery security with improved decorative properties.

The object of the invention is attained by the provision of an embossing film, in particular a hot embossing film, including a transfer layer arranged detachably on a carrier film, wherein the transfer layer has at least one colour layer whose colour appearance changes in dependence on a viewing angle, wherein the colour layer contains coloured interference pigments with a metal core.

Preferred developments of the embossing films are recited in appendant claims 2 to 13.

The object of the invention is further attained by a security document, in particular a banknote, pass, identity card, cheque card, credit card and the like, wherein arranged on the security document is a layer structure which has at least one colour layer whose colour appearance changes in dependence on a viewing angle, wherein the colour layer contains coloured interference pigments with a metal core.

Preferred developments of the security document are recited in appendant claims 15 to 24.

The term ‘viewing angle’ is used in accordance with the invention to mean the angle at which the colour layer in the transfer layer of the embossing films or the colour layer on the security document is viewed by a viewer. The viewing angle is used to mean the angle included between the normal to the surface of the film or the surface of the security document and the viewing angle of a viewing person.

In other words, with an angle of 0°, the viewer is looking perpendicularly on to the surface of the embossing film or security document. With an angle of for example 80° the viewer is looking at a very shallow angle on to the surface of the embossing film or the security document.

A change in the colour appearance of the colour layer, which is produced at the viewer, occurs in dependence on the viewing angle. Thus it is possible to readily check the authenticity of a security document on which the transfer layer having at least one colour layer changes its coloured appearance in dependence on a viewing angle.

The authenticity of such a security document, for example an identity pass or a credit card, can be checked by simply tilting the identity pass or the credit card, that is to say by altering the viewing angle. If there is no change in the coloured appearance or if a predetermined change in the coloured appearance does not occur, the viewer knows straightaway that the security document is forged.

Thus, the invention in an extremely advantageous manner provides a security element which permits checking at any time using the naked eye, that is to say without employing additional technical devices.

In addition the present invention also makes it possible to provide a transfer layer or a layer structure which is aesthetically attractive and decorative. For example it is possible to use the embossing film according to the invention to apply to corporation identity passes a colour layer which corresponds to the corporation colours and which, upon being viewed at different viewing angles, produces a predetermined change in the coloured appearance.

The information set forth hereinafter applies both in respect of a colour layer which is contained in an embossing film and also a colour layer which is applied to a security document.

The colour layer contains coloured interference pigments with a metal core, wherein a shift or change in colour shade occurs in dependence on the viewing angle, in the colour layer. Unlike pearl lustre pigments, the interference pigments with a metal core are distinguished by a strong inherent coloration. Accordingly it is possible to achieve colour changes or shifts of red/gold, blue-red and so forth.

In addition the coloured interference pigments to be used according to the invention have excellent coverage capability, by virtue of the opaque metal core. For example, a dark substrate, such as for example a black magnetic layer, can be reliably and decoratively covered with those coloured interference pigments with a metal core.

Light reflection at the surfaces of the metal cores produces a metallic effect on which is superimposed a light scatter effect at the edges of the flakes. The optical properties of the coloured interference pigments with a metal core depend on the particle shape, the particle size and the particle size distribution. The larger a pigment particle is, that is to say the smaller the fine proportion and the more regular the shape, the correspondingly higher are the brilliance and the brightness of the colour layer. The lower the fine proportion of the pigment particles, the correspondingly more saturated is the colour shade and the chromaticity in the colour layer.

When using coloured interference pigments with a metal core, the lightness depends on the angles that the light source, the surface of the colour layer and the viewer assume relative to each other. If the viewing angle approximately corresponds to the angle of incidence of the light, that is to say the glancing angle, the colour layer appears markedly lighter than when viewing angles are involved, which differ substantially from that angle of incidence or the glancing angle. That change in the appearance of the colour layer in relation to the lightness of the colour layer is determined by the ratio of directly reflected light to diffusely scattered light. That effect is more marked when coarser pigments are involved than when finer pigments are employed.

However the light is not only reflected a plurality of times by the preferably multi-layer structure when using coloured interference pigments with a metal core, but, with a suitable layer thickness, the reflected light beams can also interfere with each other and thus, in dependence on the viewing angle, result in a change in the appearance of the colour layer.

In accordance with a further preferred embodiment, contained in the colour layer, besides coloured interference pigments with a metal core, there are also further pigments, preferably coloured pigments. By admixing further pigments, it is possible to achieve any desired colour shade and it may be possible to achieve a better visible colour flop effect, for example by admixtures of carbon black.

If the colour layer contains for example coloured interference pigments with a metal core and transparent coloured pigments, a colour impression which is caused on the part of the viewer of the colour layer is afforded by a combination of the directed light reflection at the surface of the colour layer and at the metal cores of the coloured interference pigments, the light scatter effect at the metal cores and light absorption at the coloured pigments. The colour impression caused on the part of the viewer, that is to say the appearance of the colour layer, is in that case dependent on the viewing angle, at which the viewer observes the colour layer.

If the viewing angle is in the proximity of the glancing angle, the appearance of the colour layer, which is produced at the point of view of the viewer, is substantially determined by the directed reflection of the light from the metal core, as in that case the eye of the viewer is in the beam path of the reflected light.

If the eye is outside the beam path of the reflected light, that is to say if the viewing angle is markedly different from the glancing angle, the light reflected from the metal core meets the eye of the viewer, only to a minor proportion, and the appearance perceived by the viewer is determined predominantly by the diffusely scattered and absorbed light.

In the former case the colour layer appears to the viewer as shiny and bright. In the second case the colour layer appears to the viewer as dark and similar to the full shade of the coloured pigment.

A change in the colour shade of the full shade can also be produced in the colour layer, in dependence on the angle of incidence of the light. That is to be attributed to the distance covered by the light in the colour layer, which is longer when the angle of incidence is shallow, whereby more light is also absorbed.

All known metal effect pigments can be used as the metal core. Preferably the metal effect pigments are selected from the group which consists of aluminium, copper, zinc, gold-bronze, titanium, zirconium, tin and iron pigments, alloys of the aforesaid pigments and mixtures thereof.

As the coloured interference pigment with a metal core, the pigment Chromaflair® from Flex Products, Inc, Santa Rosa, Calif., USA, has proven to be highly suitable, having an intensive coloration.

In this respect, the coloured interference pigments with a metal core can have a layer or a plurality of layers of coloured metal oxides which are selected from the group which consists of TiO₂, Al₂O₃, Fe₂O₃. Cr₂O₃, SnO₂, ZrO₂, CoFe₂O₃ or CO₃O₄ and mixtures thereof. The colour of the pigments can be adjusted by way of the layer thickness of the applied metal oxide layer or an applied metal-bearing layer.

Preferably an interference layer with a suitable refractive index, preferably a vitreous layer, is applied between the metal core and the coloured metal- and/or metal oxide-bearing layer. For example an SiO₂ layer can be applied as the vitreous layer. It is however also possible to apply non-stoichiometric SiOₓ layers if those layers produce an interference effect.

Multiply coated aluminium pigments have proven to be highly suitable, in which respect an interference layer of preferably SiO₂ and subsequently a coloured metal oxide layer, preferably a layer of Fe₂O₃, are applied to an aluminium core.

That more intensive coloration of the coloured interference pigments used, with a metal core, leads to a markedly greater change in the coloured appearance in dependence on the viewing angle, that is to say an intensive colour change or colour flop, and accordingly provides for easier and more reliable recognisability in respect of the authenticity for example of a document to be safeguarded. Besides those markedly improved security properties which are achieved when using the above-specified preferred pigments, the decorative impression is also overall improved.

Besides the more intensive colour change in dependence on the viewing angle, the interference pigments with a metal core afford a very good coverage capability. In that respect those pigments can cover the usually black or dark inherent colour of a magnetic layer or a magnetic strip if the colour layer is arranged over a magnetic layer or a magnetic strip.

The inorganic coloured pigments that can be used are conventional inorganic coloured pigments such as for example iron oxide pigments, chromium oxide green pigments, chromate yellow pigments, iron blue pigments, molybdate red pigments, ultramarine pigment or mixed colour pigments. It is also possible to use oxidic mixed-phase pigments such as for example nickel titanium yellow, chrome titanium yellow, cobalt green, cobalt blue, zinc iron brown, chromium iron brown, iron manganese black, spinel black or carbon black.

Conventional organic pigments can be used as organic coloured pigments. For example it is possible to use monoazo pigments such as for example acetoacetarylide, benzimidazolone, naphthol AS, laked β-naphthol dyestuffs, diazo pigments such as for example azo-condensation pigments or dipyrazolone; polycyclic pigments such as for example quinacridone, dioxazine, perylene, diketo-pyrrolo-pyorol, isoindoline and anthraquinone derivatives; or metal complex pigments such as for example copper phthalocyanines.

In accordance with a preferred embodiment in the colour layer the pigments are embedded in a lacquer. In that respect any lacquer which is compatible with the respective pigments and which is usually employed can be used as the lacquer. For example it is possible to use lacquers based on polyesters, unsaturated polyesters, acrylates and so forth.

In accordance with a further preferred embodiment a protective layer, preferably a protective lacquer layer, is provided on the colour layer. After the transfer layer is applied to a substrate such as for example a security document, the protective layer covers the colour layer. The protective layer protects the colour layer in relation to mechanical and chemical effects. The protective layer or the protective lacquer layer does not have to be colourless, but can also be coloured. The protective lacquer layer is transparent or substantially transparent.

In accordance with a further preferred embodiment, a release layer is arranged between the carrier film and the transfer layer. The release layer can be for example a wax layer which melts when the embossing film is subjected to heat, in which case separation occurs between the carrier film on the one hand and the transfer layer on the other hand. In that arrangement the separating layer is disposed between the carrier film and the protective layer.

In accordance with a further preferred embodiment, the transfer layer, on the surface remote from the carrier film, has an adhesive layer. When a hot embossing film is applied to a substrate, for example a security document, the hot embossing film is applied with its adhesive layer against the substrate to be coated and is then subjected to heat and pressure from the carrier film side.

The adhesive layer however can alternatively also be provided on the substrate. In that case there is no need to arrange an adhesive layer on the transfer layer which for example includes a protective layer and a colour layer.

In accordance with a preferred embodiment the transfer layer includes a magnetisable layer. In that case the magnetisable layer can be of a composition, as is usually employed for example in the case of cheque or credit cards. Information can be stored on and/or read from the magnetisable layer in the usual manner.

In a preferred development of the invention the transfer layer is in the form of a strip.

For example the transfer layer which includes a protective layer and the colour layer can be in the form of a signature layer or signature strip. The signature of the authorised person is to be placed on that signature strip.

If information is to be stored on and/or read from the document to be safeguarded, the transfer layer additionally includes a magnetisable coating. In that case the magnetisable coating is preferably disposed on the surface of the colour layer, which faces away from the person viewing the colour layer.

In the transfer layer, the colour layer and the optionally provided magnetisable layer can be delimited in a region-wise manner in relation to the protective layer. This means that, when a transfer layer is applied to a substrate, for example a plastic card in the form of a cheque card, the protective layer can cover the entire surface of the plastic card and the colour layer and the optionally provided magnetisable layer can be delimited in the form of a strip which preferably extends in parallel spaced relationship with a longitudinal side of the plastic card.

The foregoing information correspondingly applies to the security document according to the invention.

In accordance with a preferred development the embossing film comprises a structure involving the following sequence: carrier film, release layer, protective layer, colour layer and optionally an adhesive layer, wherein the transfer layer includes the protective layer and the colour layer.

In accordance with a preferred development the embossing film comprises a structure involving the following sequence: carrier film, release layer, protective layer, colour layer, magnetic layer and optionally an adhesive layer, wherein the transfer layer includes the protective layer, the magnetic layer and the colour layer.

It is further preferred that provided on the security document, starting therefrom, are an adhesive layer, a colour layer and a protective layer.

In accordance with a further preferred embodiment provided on the security document, starting therefrom, are an adhesive layer, a magnetisable layer, a colour layer and a protective layer.

The information set forth hereinafter represents an embodiment given by way of example but does not limit the scope of protection of the invention.

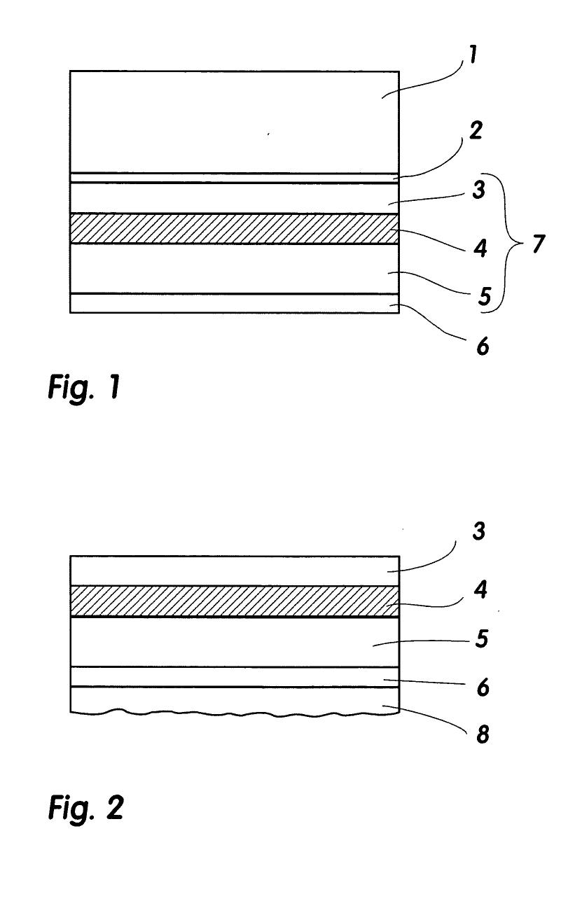

FIGS. 1 and 2 show embodiments by way of example of the invention.

FIG. 1 shows a hot embossing foil which has a structure comprising a carrier film 1, a release layer 2, a protective layer 3, a colour layer 4, a magnetisable layer 5 and an adhesive layer 6.

FIG. 2 shows a security document 8 which is provided with a layer structure, starting from the security document 8, comprising an adhesive layer 6, a magnetisable layer 5, a colour layer 4 and a protective layer 3.

The film thickness and layer thicknesses set forth hereinafter are not restricted to the specified example but can be generally used.

Film Structure

| | |
|---|---|
| carrier film 1: | film thickness: 12-26 μm, preferably |
| | 19-23 μm; material: polyester, preferably |
| | polyethylene terephthalate |
| release or separation layer 2: | wax layer usual in relation to embossing |
| | films, layer thickness: up to about 1 μm |
| protective layer 3: | layer thickness: 1-5 μm, preferably 1-3 |
| (protective lacquer): | μm, |
| colour layer 4: | layer thickness: 1-15 μm, preferably 2-8 |
| | μm, preferably using flake-form |
| | interference pigments with a metal core, |
| | for example Chromaflair ® (uncoated or |
| | multiply coated, for example in |
| | combination with organic coloured |
| | pigments), |
| magnetisable layer 5: | layer thickness: 8-30 μm, preferably 10- |
| | 20 μm, preferably using γ-iron oxide |
| | pigments for LoCo films or barium ferrite |
| | pigments for HiCo films, and |
| adhesive layer 6: | layer thickness 1-12 μm, preferably 2-7 |
| | μm. |

Composition of the Individual Layers

| | Proportions |
|---|---|
| | by weight |
| PROTECTIVE LAYER 3 | |
| Methyl ethyl ketone | 660 |
| Cyclohexanone | 110 |
| Polymethylmethacrylate (Tg: 121° C.) | 210 |
| Polyvinylidene fluoride (d = 1.75 g/m³) | 20 |
| COLOUR LAYER 4 | |
| Methyl ethyl ketone | 260 |
| Cyclohexanone | 130 |
| Polyvinylchloride/vinylacetate copolymer (Tg = 76° C.) | 110 |
| Polymethylmethacrylate (Tg: 121° C.) | 150 |
| Pigment (for example aluminium pigment, coated with SiO₂ | 350 |
| and Fe₂O₃) | |
| MAGNETISABLE LAYER 5 | |
| Methyl ethyl ketone | 370 |
| Cyclohexanone | 120 |
| Toluene | 60 |
| Thermoplastic polyurethane (Tg = 16° C.) | 45 |
| Vinylchloride/vinylacetate/vinylalcohol terpolymer | 35 |
| (Tg = 89° C.) | |
| Soya lecitin (pH = 5.9-6.9) | 10 |
| Barium ferrite (d = 5.2 g/cm³) | 360 |
| ADHESIVE LAYER 6 | |
| Methyl ethyl ketone | 540 |
| Ethyl acetate | 180 |
| Vinylchloride/vinylacetate copolymer (Tg = 76° C.) | 45 |
| Methyl/butylmethacrylate copolymer (Tg = 80° C.) | 140 |
| Polymethylmethacrylate (Tg = 128° C.) | 80 |
| Highly disperse silicon dioxide (particle size: about 10 μm) | 15 |

The release layer 2, the protective layer 3, the colour layer 4, the magnetisable layer 5 and the adhesive layer 6 are applied to the carrier film 1 by means of conventional methods, for example by printing methods, and are known to the man skilled and active in the art of the production of embossing films.

The hot embossing film produced using the foregoing compositions can be employed to produce a safeguarded security document 8, for example a banknote, a pass, an identity card, a cheque card, a credit card and the like. For that purpose the hot embossing film is applied with the adhesive layer 6 against the security document 8 to be safeguarded and subjected to the effect of heat and pressure from the carrier film side. Due to the action of heat the release layer 2 melts and the adhesive layer 6 is activated, whereby the transfer layer 7 consisting of the magnetisable layer 5, the colour layer 4 and the protective layer 3 adheres to the security document 8. The security document 8 produced in that way then includes a layer structure in the following sequence: security document 8, adhesive layer 6, magnetic layer 5, colour layer 4 and protective layer 3.

1. An embossing film, in particular a hot embossing film, including a transfer layer arranged releasably on a carrier film, wherein the layer has at least one color layer whose color appearance changes in dependence on a viewing angle, wherein the color layer contains colored interference pigments with a metal core.

2. An embossing film according to claim 1, wherein the pigments are in flake form.

3. An embossing film according to claim 1, wherein the metal core is reflecting.

4. An embossing film according to claim 1, wherein the metal core of the colored interference pigments is coated with at least one interference layer, preferably a vitreous layer, and an at least partially transparent colored metal- and/or metal oxide-bearing layer is applied to the interference layer.

5. An embossing film according to claim 1, wherein the color layer additionally contains colored pigments.

6. An embossing film according to claim 1, wherein in the color layer the pigments are embedded in a lacquer.

7. An embossing film according to claim 1, wherein the transfer layer includes a preferably transparent protective layer, the protective layer being arranged between the color layer and the carrier film.

8. An embossing film according to claim 1, wherein a release layer is arranged between the carrier film and the transfer layer.

9. An embossing film according to claim 1, wherein, on the surface remote from the carrier film, the transfer layer has an adhesive layer.

10. An embossing film according to claim 1, wherein the transfer layer includes a magnetizable layer.

11. An embossing film according to claim 9, wherein the embossing film comprises a structure in the following sequence:
carrier film
release layer
protective layer
colour color layer and
optionally an adhesive layer,
wherein the transfer layer includes the protective layer and the color layer.

12. An embossing film according to claim 10, wherein the embossing film comprises a structure in the following sequence:
carrier film
release layer
protective layer
color layer
magnetizable layer and
optionally an adhesive layer,
wherein the transfer layer includes the protective layer, the colour color layer and the magnetizable layer.

13. An embossing film according to claim 1, wherein the transfer layer is in the form of a strip.

14. A security document, in particular a banknote, pass, identity card, check card, credit card and the like, wherein arranged on the security document is a layer structure which has at least one color layer whose color appearance changes in dependence on a viewing angle, wherein the colour color layer contains colored interference pigments with a metal core.

15. A security document according to claim 14, wherein the pigments are in flake form.

16. A security document according to claim 14 wherein the metal core is reflecting.

17. A security document according to claim 14, wherein the metal core of the colored interference pigments is coated with at least one interference layer, preferably a vitreous layer, and an at least partially transparent colored metal- and/or metal oxide-bearing layer is applied to the interference layer.

18. A security document according to claim 14, wherein the color layer additionally contains colored pigments.

19. A security document according to claim 14, wherein in the color layer, the pigments are embedded in a lacquer.

20. A security document according to claim 14, wherein a protective layer is arranged on the surface of the color layer, which is remote from the security document.

21. A security document according to claim 14, wherein the layer structure includes a magnetizable layer.

22. A security document according to claim 21, wherein provided on the security document, starting from the security document, are an adhesive layer, a colour color layer and a protective layer.

23. A security document according to claim 21, wherein provided on the security document, starting from the security document, are an adhesive layer, a magnetizable layer, a colour color layer and a protective layer.

24. A security document according to claim 14, wherein the layer structure is in the form of a strip.
